(19) United States
(12) Patent Application Publication
(10) Pub. No.: US 2023/0240505 A1
(43) Pub. Date: Aug. 3, 2023

(54) POCKET HANDLE BLEND FOR AN APPLIANCE

(71) Applicant: Haier US Appliance Solutions, Inc., Wilmington, DE (US)

(72) Inventors: Aldo Vincent Kremmel, Palmyra, IN (US); Jason Allen Rowe, Louisville, KY (US)

(21) Appl. No.: 17/591,810

(22) Filed: Feb. 3, 2022

(51) Int. Cl. A47L 15/42; E05B 1/00

(52) U.S. Cl. CPC A47L 15/4257; E05B 1/0015

(57) ABSTRACT

A door for an appliance may include a door panel having a handle opening defined by a handle opening edge, a front surface, and a back surface, and a pocket handle positioned in the handle opening. The pocket handle may have a pocket handle lip resting on the front surface of the door panel and may be disposed around the handle opening edge of the door panel. The pocket handle lip may define a peripheral edge and may include the pocket handle lip and a plurality of top corners. The pocket handle lip may have a top portion, a bottom portion, and a pair of opposing side portions. The plurality of corners may be formed by the top portion and opposing side portions. At each top corner, the pocket handle may have a transverse thickness that tapers towards the peripheral edge in both a vertical direction and a lateral direction.

### FIELD OF THE INVENTION

The present subject matter relates generally to appliances, and more particularly to a pocket handle for an appliance.

### BACKGROUND OF THE INVENTION

Appliances often include a door to allow access to an internal chamber or cabinet within the appliances. The door may include a handle to aid a user in moving the door open or closed. Hence, handles aid in allowing access to the internal chamber or cabinet within an appliance. Handles included on doors come in various types and sizes.

Such handles generally include a component for a user to grip and a location behind the component to allow a user to insert a portion of their hand while gripping the aforementioned component. The user generally grasps the handle to open or close the door. The gripping component of the handle may vary among different handle types. Handle types include for example a bar extending from the door, a ledge extending from the door, a knob or pull extending from the door, and a pocket extending into the door. Pocket handles may be preferred by some consumers over other types of handles, such as those that extend from the door, as pocket handles may be more aesthetically pleasing due to their recessed nature. Pocket handles may also be desirable for their space saving abilities in small spaces, again due to their recessed nature.

However, challenges exist in the manufacture of pocket handles. Some, pocket handles may be installed as a single piece within a door, but such may be limiting on the features of the handle and may be costly to manufacture and repair. Installing a pocket handle as a separate piece to a door also has challenges. One such challenge may be providing the necessary robustness for the pocket handle while maintaining a favorable installed appearance. For example, various parts of the handles may typically require a significant minimum thickness to meet strength requirements, such as handles made of plastics. Such strength may be helpful or needed to open and close the door without significant bending of the door panels or of the pocket door handle. However, this required thickness may create undesirable aesthetics. For example, a pocket handle installed on top of a door may protrude significantly from a front surface of the door, which may contrast unaesthetically with the recessed nature of the pocket handle. Installing a door handle behind a front door panel may also incur challenges to aesthetics, such as showing installation screws or leaving a rough edge around the pocket handle at the installation site of the door.

Accordingly, an appliance door with a pocket handle that could be installed from the front door panel of the door while maintaining a recessed aesthetic would be useful. Furthermore, an appliance door that visually hid some of the features required, such as thickness for strength of a pocket handle, would also be desirable.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a door for an appliance is provided. The door may define a lateral, a vertical, and a transverse direction. The door may include a door panel having a handle opening defined by a handle opening edge, and a pocket handle positioned in the handle opening. The door panel may have a front surface and a back surface. The pocket handle may have a pocket handle lip resting on the front surface of the door panel and may be disposed around the handle opening edge of the door panel. The pocket handle lip may define a peripheral edge. The pocket handle may include the pocket handle lip and a plurality of top corners. The pocket handle lip may have a top portion, a bottom portion, and a pair of opposing side portions. The plurality of corners may be formed by the top portion and opposing side portions. At each top corner, the pocket handle may have a transverse thickness that tapers towards the peripheral edge in both the vertical and lateral directions.

In another exemplary aspect of the present disclosure, a door for an appliance is provided. The door may define a lateral, a vertical, and a transverse direction. The door may include a door panel having a handle opening defined by a handle opening edge, and a pocket handle positioned in the handle opening. The door panel may have a front surface and a back surface. The pocket handle may include a pocket handle lip resting on the front surface of the door panel and disposed around the handle opening edge of the door panel, and at least one corner. The pocket handle may include a top portion, a bottom portion, a pair of opposing side portions and may define a peripheral edge. The at least one corner may be formed by at least one opposing side portion and at least one of the top portion and the bottom portion. At each corner, the pocket handle may have a transverse thickness that tapers towards the peripheral edge in both the vertical and lateral directions.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary embodiment of a dishwasher appliance of the present disclosure;

FIG. 2 provides a side, cross sectional view of the exemplary dishwasher appliance of FIG. 1;

FIG. 3 provides a front perspective view of an exemplary embodiment of a door of the present disclosure;

FIG. 4 provides a section front view of a section of the exemplary door of FIG. 3;

FIG. 5 provides a cross sectional, perspective view of a portion of the exemplary door of FIG. 3;

FIG. 6 provides a side, sectional view of a portion of the exemplary door of FIG. 3;

FIG. 7 provides a sectional perspective view of a portion of the exemplary door of FIG. 3;

FIG. 8 provides a diagonal, sectional view of an exemplary corner of a handle of the exemplary door of FIG. 3;

FIG. 9 provides a top elevation view of a portion of the exemplary door of FIG. 3;

FIG. 10 provides a side elevation view of a portion of the exemplary door of FIG. 3; and

FIG. 11 provides a side, sectional view of a section of the exemplary door of FIG. 3.

Use of the same of similar reference numerals in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising.” As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. Terms such as “inner” and “outer” refer to relative directions with respect to the interior and exterior of the oven appliance, and in particular the chamber(s) defined therein. For example, “inner” or “inward” refers to the direction towards the interior of the oven appliance. Terms such as “left,” “right,” “front,” “back,” “top,” or “bottom” are used with reference to the perspective of a user accessing the appliance (e.g., when the door is in the closed position). For example, a user stands in front of the appliance to open a door and reaches into the internal chamber(s) to access items therein.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise, or counterclockwise, with the vertical direction V).

As used herein, the term “article” may refer to, but need not be limited to dishes, pots, pans, silverware, and other cooking utensils and items that can be cleaned in a dishwashing appliance. The term “wash cycle” is intended to refer to one or more periods of time during which a dishwashing appliance operates while containing the articles to be washed and uses a detergent and water, preferably with agitation, to e.g., remove soil particles including food and other undesirable elements from the articles. The term “rinse cycle” is intended to refer to one or more periods of time during which the dishwashing appliance operates to remove residual soil, detergents, and other undesirable elements that were retained by the articles after completion of the wash cycle. The term “drain cycle” is intended to refer to one or more periods of time during which the dishwashing appliance operates to discharge soiled water from the dishwashing appliance. The term “wash fluid” refers to a liquid used for washing and/or rinsing the articles and is typically made up of water that may include other additives such as detergent or other treatments.

As will be understood by those skilled in the art, dishwasher appliance 100 is provided by way of example only, and the present subject matter may be used in any suitable household appliance. Thus, the present subject matter may be used with other dishwasher appliances having different configurations, including more or less rack assemblies, more or less spray assemblies, etc. The present subject matter may further be used with other household appliances such as microwave ovens, washing machine appliances, dryer appliances, oven appliances, refrigerator appliances, etc. Dishwasher appliance 100 will be described below, with the understanding that other embodiments may include or be provided as another suitable household appliance (e.g., defining an internal chamber).

In certain exemplary embodiments described herein, a pocket handle is provided within a handle opening of a door panel. The pocket handle may have at least one corner, wherein the thickness in transverse direction T of the corner tapers in two directions towards a peripheral edge of the pocket handle. The tapering of the corners may appear as if the pocket handle is thin relative to the door and may also appear as nearly flush with the door panel. At the same time, the pocket handle can have robustness of structural integrity particularly in areas where a user will apply forces during opening and closing of the door. Furthermore, the pocket handle configuration can allow for an aesthetically pleasing appearance and minimize space requirements in transverse direction T as compared to others handles that may extend out from the door panel.

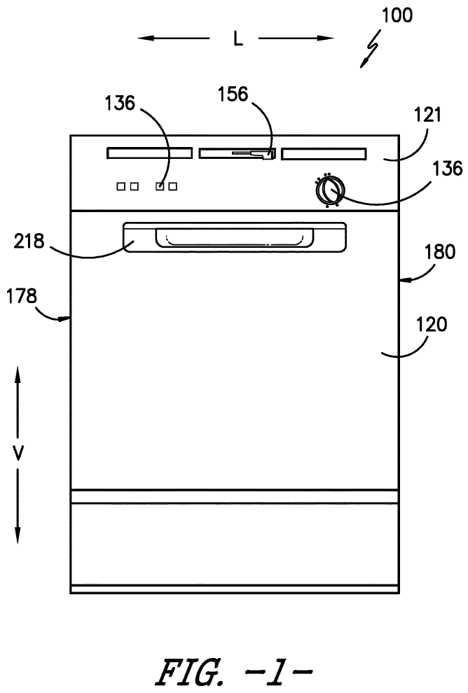

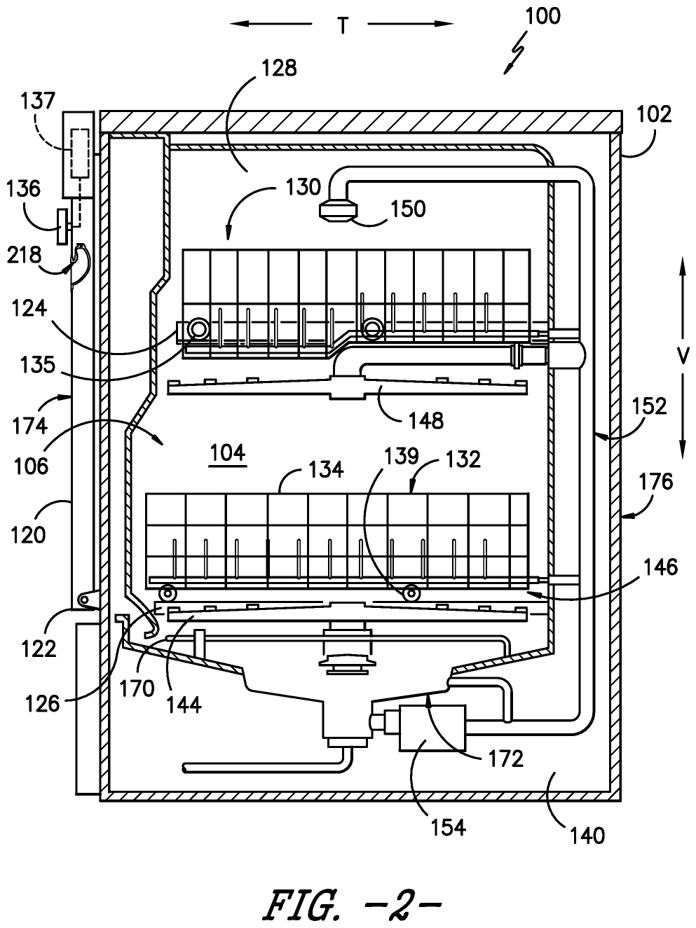

For example, FIGS. 1 and 2 depict an exemplary domestic dishwasher 100 with door 120 that may be configured in accordance with aspects of the present disclosure. Appliance 100 and door 120 define a lateral direction L, a vertical direction V, and a transverse direction T that are mutually orthogonal to one another as shown in FIGS. 2 through 11. References to these orthogonal directions when specifically describing door 120 are based on door 120 being in a closed position as shown in FIG. 2. Appliance 100 includes a front 174 and back 176 with reference to transverse direction T and opposing sides 178 and 180 with reference to lateral direction L.

As illustrated in FIGS. 1 and 2, exemplary embodiments of dishwasher 100 include a cabinet 102 having a tub 104 therein that defines a wash chamber 106. Tub 104 includes a front cabinet opening (not shown) and a door 120 hinged at its bottom 122 for movement between a normally closed vertical position (shown in FIGS. 1 and 2), wherein wash chamber 106 is sealed shut for washing operations, and a horizontal open position for loading and unloading of articles from dishwasher 100. Latch 156 is used to lock and unlock door 120 for access to wash chamber 106.

In some embodiments, upper and lower guide rails 124, 126 are mounted on tub side walls 128 and accommodate roller-equipped rack assemblies 130 and 132. Each of rack assemblies 130, 132 may be fabricated into lattice structures including a plurality of elongated members 134 (for clarity of illustration, not all elongated members making up rack assemblies 130 and 132 are shown in FIG. 2). Each rack 130, 132 is adapted for movement between an extended loading position (not shown), in which rack 130 or 132 is substantially positioned outside wash chamber 106, and a retracted position (shown in FIGS. 1 and 2), in which rack 130 or 132 is located inside wash chamber 106. This rack movement is facilitated by rollers 135 and 139, for example, mounted onto racks 130 and 132, respectively. A silverware basket (not shown) may be removably attached to rack assembly 132 for placement of silverware, utensils, and the like that are otherwise too small to be accommodated by racks 130, 132.

In certain embodiments, dishwasher 100 further includes a lower spray-arm assembly 144 that is rotatably mounted within a lower region 146 of wash chamber 106 and above a tub sump assembly 172 so as to rotate in relatively close proximity to rack assembly 132. Additionally or alternatively, a mid-level spray-arm assembly 148 may be located in an upper region of wash chamber 106 and may be located in close proximity to upper rack 130. Also additionally or alternatively, an upper spray assembly 150 may be located above upper rack 130.

Lower and mid-level spray-arm assemblies 144, 148 and upper spray assembly 150 may be part of a fluid circulation assembly 152 for circulating water and dishwasher fluid in tub 104. Fluid circulation assembly 152 may also include a recirculation pump 154 positioned in a machinery compartment 140 located below tub sump assembly 172 (e.g., bottom wall) of tub 104. Pump 154 may receive fluid from sump assembly 172 to provide a flow to fluid circulation assembly 152, or optionally, a switching valve or diverter (not shown) may be used to select flow. A heating element 170 can be used to provide heat during e.g., a drying cycle.

Each spray-arm assembly 144, 148 may include an arrangement of discharge ports or orifices for directing washing fluid received from pump 154 onto dishes or other articles located in rack assemblies 130 and 132. The arrangement of the discharge ports in spray-arm assemblies 144, 148 can provide a rotational force by virtue of washing fluid flowing through the discharge ports. The resultant rotation of the spray-arm assemblies 144, 148 and the operation of spray assembly 150 using fluid from pump 154 provides coverage of dishes and other dishwasher contents with a washing spray. Other configurations of spray assemblies may be used as well.

Dishwasher 100 is further equipped with a controller 137 to regulate operation of dishwasher 100. Controller 137 may include one or more memory devices and one or more microprocessors, such as general or special purpose microprocessors operable to execute programming instructions or micro-control code associated with a cleaning cycle. The memory may represent random access memory such as DRAM or read only memory such as ROM or FLASH. In one embodiment, the processor executes programming instructions stored in memory. The memory may be a separate component from the processor or may be included onboard within the processor.

Controller 137 may be positioned in a variety of locations throughout dishwasher 100. In the illustrated embodiment, controller 137 is located within a control panel area 121 of door 120 as shown in FIGS. 1 and 2. In some such embodiments, input/output (“I/O”) signals may be routed between controller 137 and various operational components of dishwasher 100 along wiring harnesses that may be routed through bottom 122 of door 120. Typically, controller 137 includes a user interface panel/controls 136 through which a user may select various operational features and modes and monitor progress of dishwasher 100. In some embodiments, user interface 136 represents a general purpose I/O (“GPIO”) device or functional block. In additional or alternative embodiments, user interface 136 includes input components, such as one or more of a variety of electrical, mechanical, or electro-mechanical input devices including rotary dials, push buttons, and touch pads. User interface 136 may include a display component, such as a digital or analog display device designed to provide operational feedback to a user. User interface 136 may be in communication with controller 137 via one or more signal lines or shared communication busses.

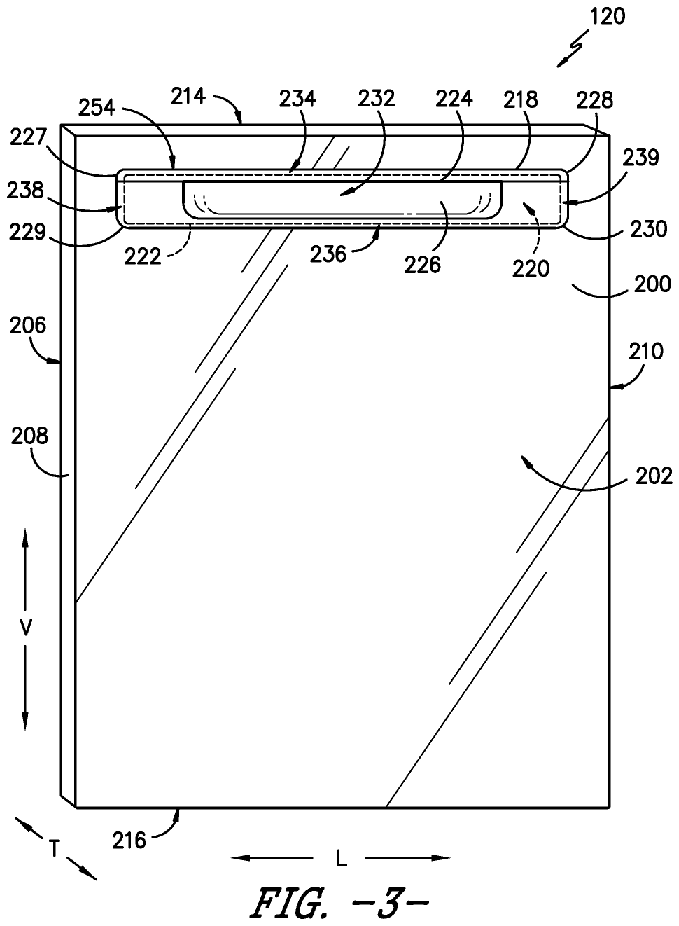

Turning to FIGS. 3 through 11, for this exemplary embodiment, door 120 includes a door panel 200 with handle 218. Door 120 includes a pair of side panels 208, 210 and a rear panel 206. Door 120 includes a top panel 214 and a bottom panel 216. Door 120 includes a door cavity 212 positioned between panel 200 and rear panel 206.

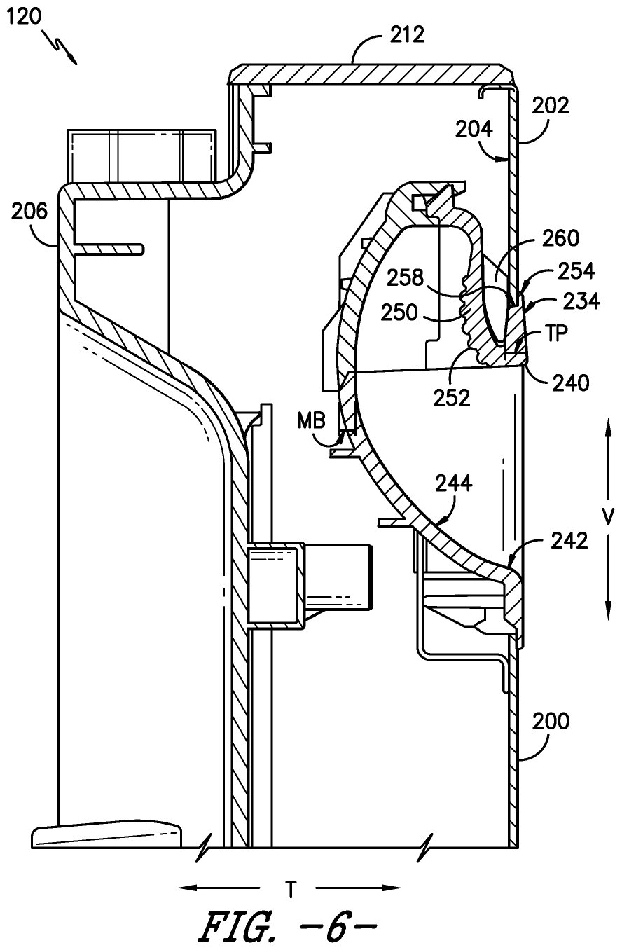

Door panel 200 includes a front surface 202 and a back surface 204 (FIG. 5). When 120 is in the closed position, door panel 200 lies in a plane that includes vertical direction V and lateral direction L. As shown in FIG. 3, front surface 202 of door panel 200 includes a handle opening edge 222 that defines a handle opening 220. Handle opening 220 may connect with door cavity 212. Handle 218 is positioned in handle opening 220 and, for this embodiment, covers handle opening 220 by extending completely around, and in contact with, handle opening edge 222. In certain embodiments, handle opening edge 222 has linear portions that extend along door panel 200 in both the lateral direction L and vertical direction V. For this embodiment, handle opening 220 and is positioned vertically in the upper half of door panel 200 but may be positioned elsewhere in other embodiments and may also have different overall shapes and proportions.

For this exemplary embodiment, handle 218 is a pocket handle 218 that includes a handle cavity 232 for receipt of e.g., a user's hand or fingers. Pocket handle 218 includes a pocket handle lip 224 (FIG. 3) that rests on front surface 202 of door panel 200 and is disposed around handle opening edge 222. Pocket handle lip 224 includes a top portion 234, a bottom portion 236, and a pair of side portions 238, 239.

Pocket handle 218 also includes a main body portion 226 that extends within handle opening 220 and a plurality of corners (e.g., corners 227, 228, 229, 230). In some embodiments, the plurality of corners 227, 228, 229, 230 may only include a plurality of top corners 227, 228 or only a plurality of bottom corners 229,

Plurality of top corners 227, 228 are formed by top portion 234 and pair of opposing side portions 238, 239. Plurality of bottom corners 229, 230 are formed by bottom portion 236 and pair of opposing side portions 238, 239. In some embodiments, top corners 227, 228 are blended with top portion 234 of pocket handle lip 224. In certain embodiments, bottom corners 229, 230 are blended with bottom portion 236 or pair of opposing side portions 238, 239.

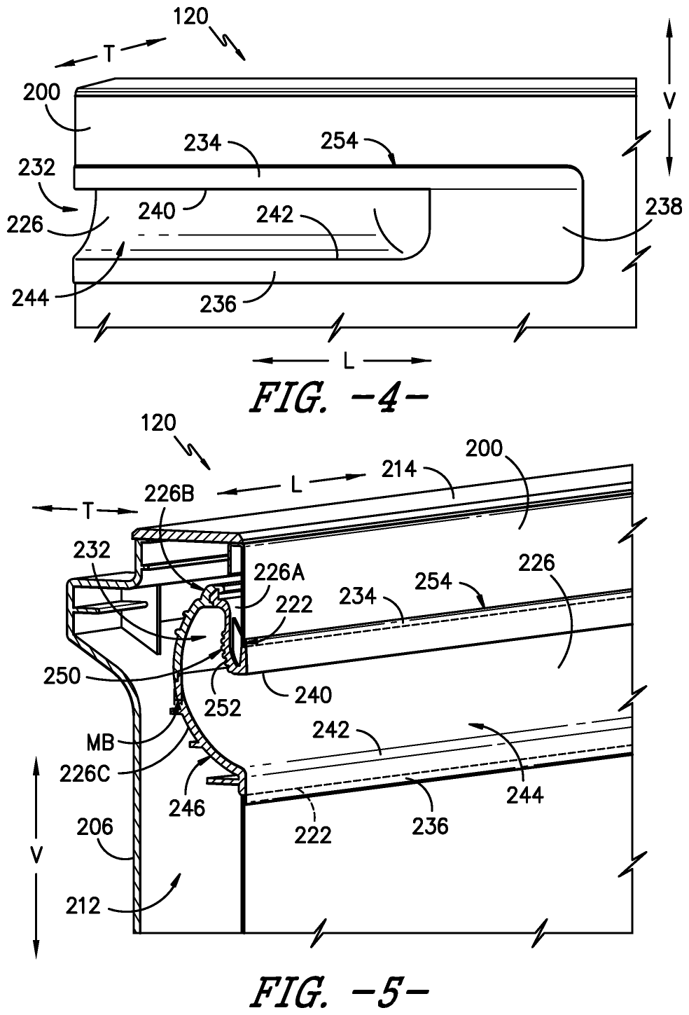

As shown in FIGS. 3 and 4, main body portion 226 defines handle cavity 232. Main body portion 226 extends between top portion 234 and bottom portion 236 of pocket handle lip 224, and extends between pair of side portions 238, 239. As shown, main body portion 226 has an upper end 240 abutting top portion 234 of pocket handle lip 224. Main body portion 226 also has a lower end 242 abutting bottom portion 236. Main body portion 226 extends into door 120 in between upper end 240 and lower end 242, forming handle cavity 232 therebetween. Main body portion 226 further curves inward toward rear panel 206 of door 120, defining handle cavity 232 of pocket handle 218. Handle cavity 232 may be sized to allow a user's hand to grip pocket handle 218, the user inserting at least a portion of a user's hand into handle cavity 232 to maneuver door 120 between the open position and the closed position.

Main body portion 226 of handle 218 further includes a cavity surface 244 that is a front facing or outer surface of handle 218 and external to door cavity 212. As shown in FIG. 5, main body portion 226 further has a body thickness MB between cavity surface 244 and an opposing rear surface 246. In some embodiments, main body portion 226 includes more than one discrete part attached together, such as main body parts 226A, 226B, and 226C as shown in in FIG. 5. In certain embodiments, main body portion 226 is a unitary part of door 120. In some embodiments, main body 226 and pocket handle lip 224 form a unitary piece of handle 218.

Handle cavity 232 defined by main body portion 226 extends through handle opening 220. As shown in FIG. 3, handle cavity 232 is defined in vertical direction V between upper end 240 and lower end 242 of main body portion 226, and handle cavity 232 extends in lateral direction L across handle 218 between side portions 238, 239. Returning to FIG. 5, for this exemplary embodiment, handle cavity 232 further extends in vertical direction V above handle opening edge 222 and behind door panel 200. In some embodiments, handle cavity 232 does not extend in vertical direction V above handle opening edge 222 or behind door panel 200.

As shown in FIGS. 5 and 6, cavity surface 244 on main body portion 226 includes a grip portion 250 extending along lateral direction L. At least one textured grip 252 is located on grip portion 250 of cavity surface 244. As shown, grip portion 250 extends behind top portion 234 of handle lip 224. During use, grip portion 250 with textured grip 252 may aid a user in gripping handle 218 to move door 120 between the open position and the closed position. In some embodiments, grip portion 250 may begin below (not shown) or behind (FIG. 5) upper end 240 of main body portion 226.

Pocket handle lip 224 defines a peripheral edge 254 (FIGS. 4 and 5). Peripheral edge 254 abuts front surface 202, and peripheral edge 254 extends along vertical direction V and along lateral direction L beyond handle opening edge 222. In some embodiments, at least a portion of pocket handle lip 224 overlaps front surface 202. In certain embodiments, a majority of pocket handle lip 224 overlaps front surface 202. Turning to FIG. 6, handle lip 224 at peripheral edge 254 includes a bevel roughly orthogonal to front surface 202 for this exemplary embodiment.

As shown in FIG. 6, along transverse direction T, grip portion 250 is located behind top portion 234 and behind back surface 204 of door 120. In some embodiments, pocket handle 218 defines a groove or U-shaped channel 258 between top portion 234 and grip portion 250. During use, U-shaped channel 258 aids in securing pocket handle 218 to door panel 200, with handle opening edge 222 being secured in U-shaped channel 258. Additionally or alternatively, grip portion 250 may include at least one rib 260 that abuts back surface 204 of door panel 200. In certain embodiments, rib(s) 260 aid in defining U-shaped channel 258. Additionally or alternatively, pocket handle 218 may be attached to handle opening edge 222 of door panel 200 by snaps, flanges, or other fasteners including screws, nails, rivets, adhesives, or equivalent means.

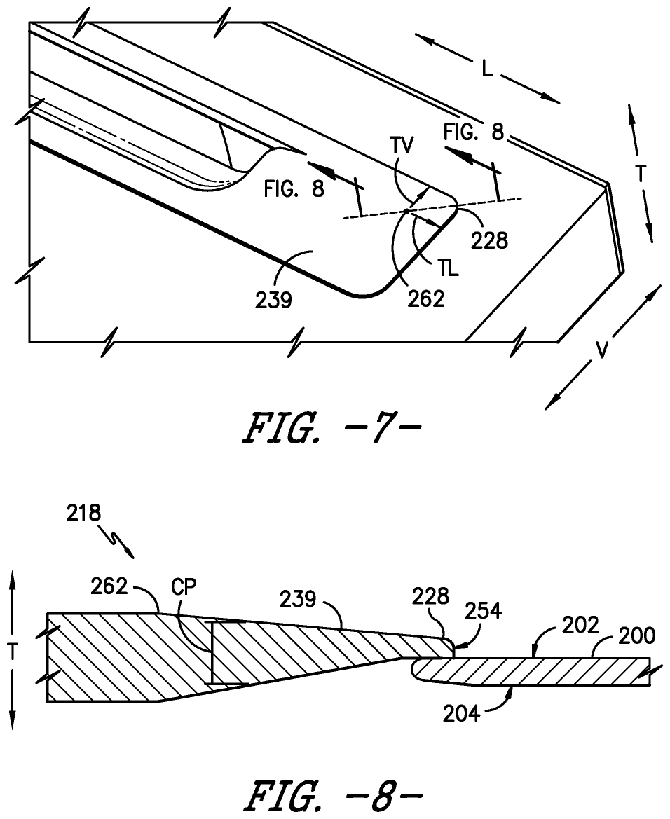

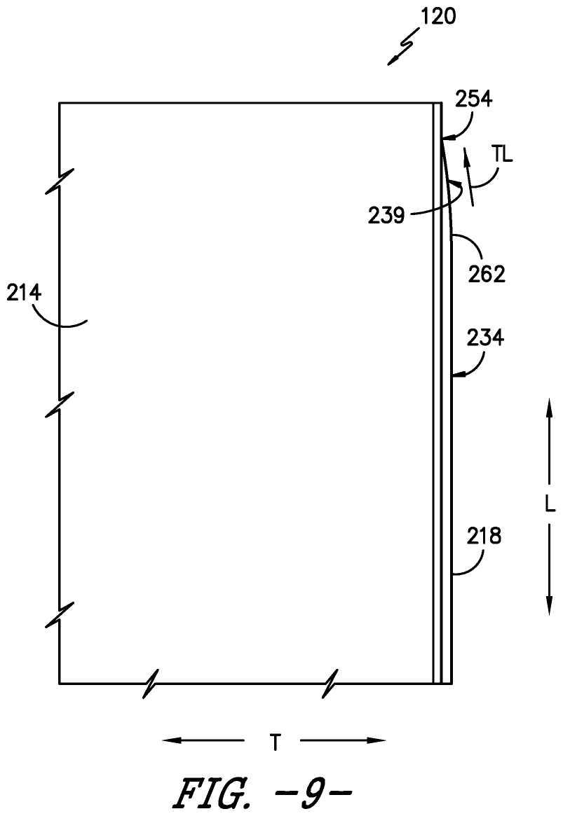

Turning to FIGS. 7 and 8, at top corner 228, pocket handle 218 has a thickness CP in transverse direction T. Furthermore, handle 218 at each corner 227, 228, 229, 230 has a thickness CP in transverse direction T (as shown in FIG. 8). Thickness CP tapers in both the vertical direction V and lateral direction L for at least one corner 227, 228, 229, or 230. For example, plurality of top corners 227, 228 tapers in both the vertical direction V and the lateral direction L. Taper directions 264, 265 depict directions of taper, with thickness CP decreasing gradually in taper directions 264, 265 from beginning of corner taper at beginning point 262 toward peripheral edge 254.

FIG. 8 depicts a diagonal sectional view of corner 228, along the plane shown in FIG. 7. FIG. 8 illustrates tapering in the lateral direction L and vertical direction V. Thickness CP decreases gradually from a beginning 262 of corner taper of corner 228 in both vertical direction V and lateral direction L and decreasing to a minimum thickness CP at peripheral edge 254. Furthermore, a thickness in transverse direction T of any of the corners 227, 229, 230 may gradually decrease from a beginning point 262 to peripheral edge 254, tapering in lateral direction L and vertical direction V as described for corner 228 herein. For example, in some embodiments, bottom thickness CP in transverse direction T tapers towards peripheral edge 254 in vertical direction V and lateral direction L.

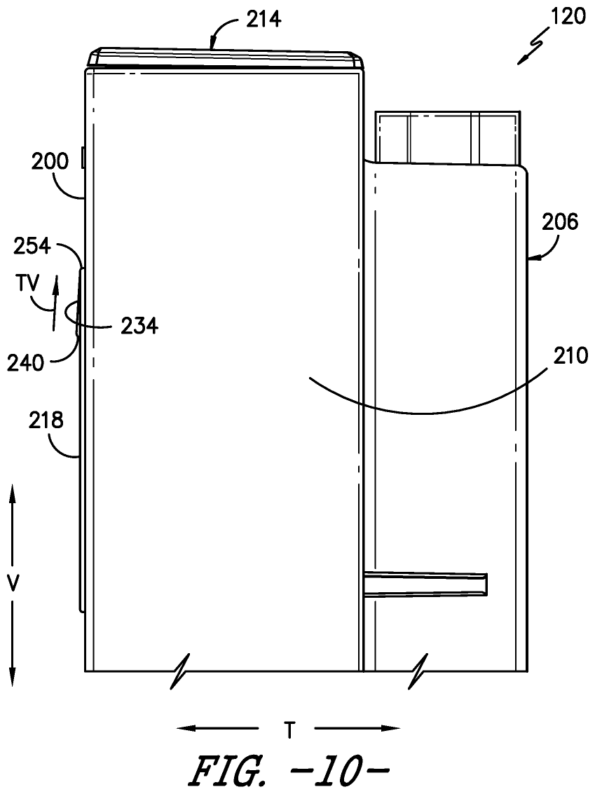

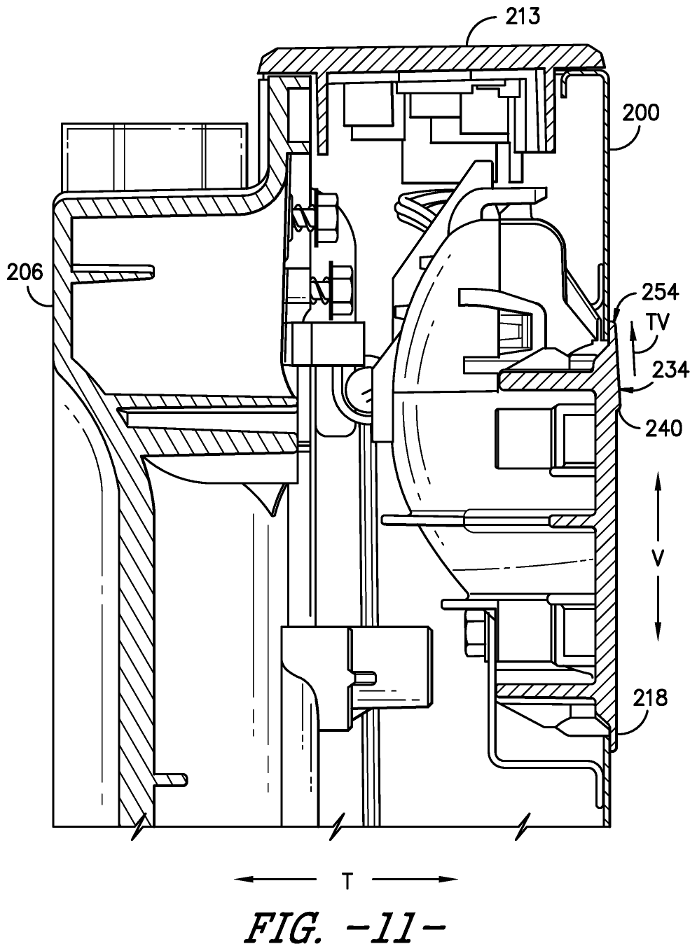

FIG. 9 depicts a tapering direction TL in lateral direction L toward peripheral edge 254 and FIG. 10 depicts a tapering direction TV in vertical direction V toward peripheral edge 254 (as also seen in FIG. 7). Taper of at least one corner 227, 228, 229 and/or 230 may occur in a manner that visually appears very minimal in terms of the perceived change thickness. In the illustrated embodiments, gradual taper along taper directions TL and TV serves to visually disguise the difference the protrusion of pocket handle 218 along transverse direction T relative to door panel 200. In certain embodiments, the difference in taper along pocket handle 218 aids in making the handle appear nearly flush with door panel 200 in transverse direction T. For example, in some embodiments, thickness CP at peripheral edge 254 and corner 228 is between about 33 percent and about 50 percent as compared to thickness CP at beginning 262 of corner taper.

In some embodiments, top portion 234 between plurality of corners (e.g., top corners 227, 228) tapers towards peripheral edge 254 in vertical direction V. For example, top thickness TP at upper end 240 is thicker than top thickness TP of top portion 234 at peripheral edge 254. As shown in FIGS. 5 and 6, top thickness TP between upper end 240 and peripheral edge 254 at top portion 234 gradually decreases towards peripheral edge 254. In certain embodiments, the top thickness TP in transverse direction T at peripheral edge 254 is between about 33 and about 50 percent less thick than top thickness TP in transverse direction T at upper end 240.

For the exemplary embodiments of FIGS. 5, 6, 10 and 11, top thickness TP in transverse direction T at upper end 240 is thicker than body thickness MB, generally in transverse direction T, along cavity surface 244 of main body portion 226. As such, top thickness TP is greater than body thickness MB (e.g., along handle cavity 232). In the illustrated embodiments, top portion 234 of handle lip 224 extends in transverse direction T forward of the other elements of handle 218 at connection of top portion 234 to upper end 240 of main body 226. Advantageously, the additional thickness at upper end 240 can allow for added strength at grip portion 250, the position where a user is likely to apply direct force to open or close door 120.

In additional or alternate embodiments, bottom portion 236 of handle lip 224 tapers in vertical direction V towards peripheral edge 254, in a fashion similar to taper of top portion 234 of handle lip 224, as described herein. In some embodiments, bottom portion 236 has a thickness in transverse direction T that is thicker than body thickness MB along cavity surface 244 of main body portion 226, bottom portion 236 thickness tapering towards peripheral edge 254.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A door for an appliance, the door defining a lateral, a vertical, and a transverse direction, the door comprising:
a door panel having a handle opening defined by a handle opening edge, the door panel having a front surface and a back surface; and
a pocket handle positioned in the handle opening, the pocket handle comprising
a pocket handle lip resting on the front surface of the door panel and disposed around the handle opening edge of the door panel, the pocket handle lip defining a peripheral edge, the pocket handle lip comprising a top portion, a bottom portion, and a pair of opposing side portions; and
a plurality of top corners formed by the top portion and opposing side portions,
wherein at each top corner the pocket handle has a thickness in the transverse direction that tapers towards the peripheral edge in both the vertical and lateral directions.

2. The door of claim 1, wherein the top portion between the plurality of top corners tapers towards the peripheral edge in the vertical direction.

3. The door of claim 1, wherein the handle comprises a main body portion between the top portion, the bottom portion, and the pair of opposing side portions, the main body portion having a body thickness in the transverse direction, and
wherein the top portion between the top corners has a top thickness in the transverse direction that is greater than the body thickness in the transverse direction of the main body portion.

4. The door of claim 3, wherein the top portion between the plurality of top corners tapers towards the peripheral edge in the vertical direction.

5. The door of claim 1, wherein the handle comprises a main body portion between the top portion, the bottom portion, and the pair of opposing side portions, the main body portion having a body thickness in the transverse direction, and
wherein the main body portion defines a handle cavity, the handle cavity extending through the handle opening.

6. The door of claim 5, wherein the handle cavity further extends vertically above the handle opening edge and behind the door panel.

7. The door of claim 6, wherein the handle further comprises a cavity surface further defining the handle cavity on the main body portion of the handle, and a textured grip located on a grip portion of the cavity surface, the textured grip configured to aid a user in gripping the handle to move the door.

8. The door of claim 1, wherein the pocket handle further comprises a plurality of bottom corners formed by the bottom portion and the pair of opposing side portions.

9. The door of claim 8, wherein at each bottom corner in the plurality of bottom corners, the pocket handle has a bottom thickness in the transverse direction that tapers towards the peripheral edge in both the vertical and lateral directions.

10. The door of claim 1, wherein the handle forms a bevel at the peripheral edge, the peripheral edge roughly orthogonal to the front surface of the door.

11. The door of claim 1, wherein the plurality of top corners are blended with the top portion.

12. The door of claim 1, wherein the pocket handle further comprises a grip portion located behind the top portion and behind the back surface of the door, and
wherein the pocket handle defines a U-shaped channel between the top portion and the grip portion, the top portion extending beyond the handle opening edge behind the back surface of the door.

13. The door of claim 12, wherein the handle opening edge is secured in the U-shaped channel.

14. A door for an appliance, the door defining a lateral, a vertical, and a transverse direction, the door comprising:
a door panel having a handle opening defined by a handle opening edge, the door panel having a front surface and a back surface; and
a pocket handle positioned in the handle opening, the pocket handle comprising
a pocket handle lip resting on the front surface of the door panel and disposed around the handle opening edge of the door panel, the pocket handle lip comprising a top portion, a bottom portion, a pair of opposing side portions, and defining a peripheral edge; and
at least one corner formed by at least one opposing side portion and at least one of the top portion and the bottom portion,
wherein, at each corner, the pocket handle has a thickness in the transverse direction that tapers towards the peripheral edge in both the vertical and lateral directions.

15. The door of claim 14, wherein the at least one corner comprises a plurality of top corners formed by the pair of opposing side portions and the top portion.

16. The door of claim 15, wherein the top portion between the plurality of top corners tapers towards the peripheral edge in the vertical direction.

17. The door of claim 15, wherein the handle comprises a main body portion between the top portion, the bottom portion, and the pair of opposing side portions, the main body portion having a body thickness in the transverse direction, and
wherein the top portion between the plurality of top corners has a top thickness in the transverse direction greater than the body thickness in the transverse direction of the main body portion.

18. The door of claim 14, wherein the handle defines a handle cavity, the handle cavity extending through the handle opening, and
wherein the handle cavity further extends vertically above the handle opening edge and behind the door panel.
